(19) United States
(12) Patent Application Publication
(10) Pub. No.: US 2011/0154386 A1
(43) Pub. Date: Jun. 23, 2011

(54) ANNOTATED ADVERTISEMENT REFERRAL SYSTEM AND METHODS

(75) Inventors: Munir Cochinwala, Basking Ridge, NJ (US); John R. Wullert, II, Martinsville, NJ (US)

(73) Assignee: TELCORDIA TECHNOLOGIES, INC., Piscataway, NJ (US)

(21) Appl. No.: 12/644,489

(22) Filed: Dec. 22, 2009

(51) Int. Cl. H04N 7/16; G06Q 30/00; H04N 7/10

(52) U.S. Cl. 725/14; 705/14.49; 725/35

(57) ABSTRACT

A system and methods provide an annotated advertisement referral for presentation on an electronic device by employing the steps of receiving at an electronic processor an indication of a referral of an advertisement and the identity of a target to whom the advertisement is referred, and then directing the electronic signal representing a version of that advertisement to an electronic device associated with that target to whom the advertisement is referred. Preferably, that directed electronic signal includes an indication of the origin of the referral and a ranking of the advertisement given by the referring party.

### BACKGROUND

1. Technical Field

The system and methods disclosed herein relate to the field of advertisement distribution control and, more specifically, to a system and methods that direct distribution of advertisements to consumers upon referral, which are preferably annotated to indicate that referral.

2. Description of the Related Art

Television viewers are often interrupted by commercials for products in which they have no interest. One response is to use devices to time-shift viewing, which allows users to skip past such commercials. Free television programming, however, is paid for by advertising and, accordingly, having technologies that allow users to bypass commercials undercuts the basic financial model that supports such programming.

There have been several attempts to target advertisements to users. Advertisers do this, for example, by selecting the types of programming during which they advertise their products, hoping to leverage alignment between interest in a particular program and interest in a specific product. This is generally done based on demographics and events, such as targeting males between the ages of 18-35 during a sporting event with products in which such individuals would likely have an interest.

Television networks also target by location, reserving some advertising slots within a program for use by local broadcasters to use for advertisements that reach a more limited geographic area. Cable television systems, particularly newer systems that offer on-demand programming using digital techniques, have looked at finer-grained targeting using information such as subscriber zip codes, subscriber on-demand selections, or even utilizing information from third-target databases.

This problem of targeting advertisements is also evident in the World Wide Web, where many websites depend on revenue from advertising as well. In the case of websites, one approach is to target advertisements to potential consumers based on profile information. For example, advertisements might be selected based on the words the potential consumer has entered into a search engine.

Systems also use “cookies” or other technology to store a large number of user searches in order to obtain a clearer view of consumer interests and needs. This information is used as a basis for determining which advertisements to display to particular website users. In addition, in cases where users establish a relationship with a business supporting the website, other information collected from or about the users, such as address, prior purchases, and age, can be used in targeting advertisements as well. Such systems have been proposed for both website advertising and television-related advertising.

The fact is that consumers are more likely to watch commercials if they are interested in the associated products or services. There is, accordingly, a need on the part of broadcasters and advertisers to find a way to better target advertisements to individuals in order to maintain their interest.

### SUMMARY

The present invention provides a means whereby persons exposed to a particular advertisement can annotate that advertisement with comments or indications of areas of interest and then recommend that advertisement to friends or colleagues. Such recommended advertisements, including the annotations, can then be made available for review by the identified friends or colleagues. This mechanism can work for television, the Internet, or even telephone advertising. Referrals may be targeted toward specific persons or to general types or categories of persons.

In one embodiment, a method provides an annotated advertisement referral for presentation on an electronic device. The electronic device preferably includes a visual device, such as a television screen, smart phone, or computer monitor, but in the alternative, it may be an audio device, such as a cable-supported radio or conventional telephone. This method includes the steps of receiving at an electronic processor an indication of a referral of an advertisement and the identity of the target individual to whom the advertisement is referred. This method further includes the step of directing an electronic signal representing a version of the advertisement to an electronic device associated with that target individual to whom the advertisement is referred.

Preferably, the method includes not only directing an electronic signal representing a display of a version of the advertisement to electronic device, but also directing an indication of the origin of the referral to that electronic device. That signal may, for example, include both visional and audio aspects.

Consistent with another embodiment of the invention, a method for providing an annotated advertisement referral for presentation on an electronic device comprises the steps of: directing a first electronic signal representing an advertisement to a first electronic device; receiving at an electronic processor a second electronic signal from the first electronic device indicating a referral of that advertisement and the identity of a target to whom the advertisement is referred; and directing a third electronic signal representing a version of the advertisement to a second electronic device associated with the target individual to whom the advertisement is referred, the version of the advertisement including an indication of the origin of the referral.

Still further, the invention may take the form of a system for providing an annotated advertisement referral on an electronic device. Such a system, for example, may take the form of a first interactive electronic device configured to present an advertisement and generate a referral signal and the identity of a target to whom the referral is being made in response to user input; a second electronic device configured to present an advertisement; and an electronic processor programmed to: direct a first electronic signal representing a first advertisement to the first interactive electronic device; recognize receipt from the first interactive electronic device of a referral signal; and direct a second electronic signal representing a version of the advertisement to the second electronic device in response to the identity of a target to whom the referral is being made. Preferably, this second electronic signal includes an indication of an origin of the referral.

Both the system and methods of the present invention may also include user input of a rating signal and transmittal of an indication of that rating signal to the ultimate viewer of the advertisement. This rating signal may also be utilized to determine which advertisements are to be sent to ultimate viewers.

It is important to understand that both the foregoing general description and the following detailed description are exemplary and explanatory only, and are not restrictive of the invention as claimed.

### BRIEF DESCRIPTION OF THE DRAWING

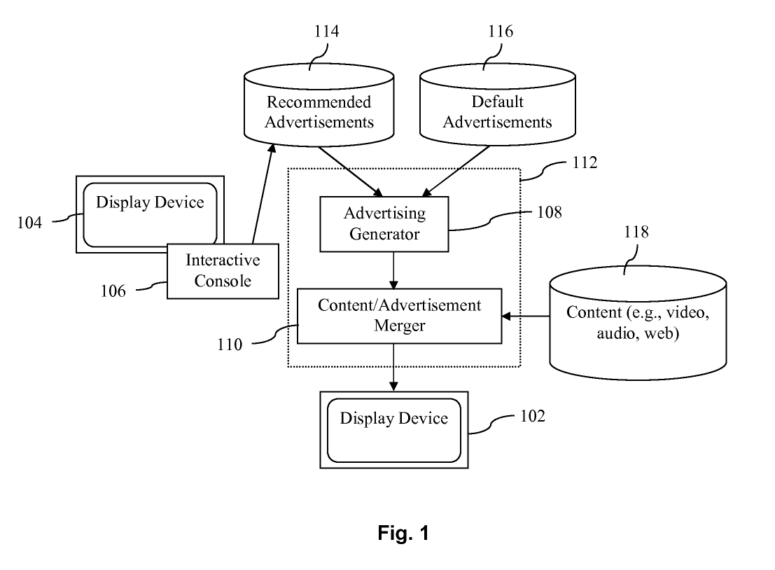

The accompanying drawing, which is incorporated in and constitutes a part of this specification, illustrates various embodiments. In the drawing, FIG. 1 illustrates a system that incorporates the principles of the present invention.

### DESCRIPTION OF THE EMBODIMENTS

In the following description, for purposes of explanation and not limitation, specific techniques and embodiments are set forth, such as particular sequences of steps, interfaces, and configurations, in order to provide a thorough understanding of the techniques presented here. While the techniques and embodiments will primarily be described in the context of the accompanying drawing, those skilled in the art will further appreciate that the techniques and embodiments can also be practiced in other electronic devices or systems.

Reference will now be made in detail to exemplary embodiments of the present invention, an example of which is illustrated in the accompanying drawing.

FIG. 1 illustrates one example of a system for providing an annotated advertisement referral for an electronic device. In the system disclosed in FIG. 1, that electronic device is display device 102. Display device 102 may, for example, comprise a conventional television, a conventional monitoring system associated with a personal computer and communications with the Internet, a smart phone, a conventional phone, or any similar communication device upon which an advertisement may be displayed. The term “displayed” in the context of this invention is to be broadly interpreted to include not only a visual presentation, but also an audio presentation of the advertising material, or a combination of both a visual and audio presentation. Thus, the advertisement may be presented in a visual form, an entirely audio form, or combination of visual and audio forms.

The system shown in FIG. 1 further includes an interactive display device 104. Display device 104 is intended to be representative of any interactive electronic device configured to present an advertisement and to generate a referral signal and the identity of a target individual to whom the referral is being made in response to user input. Thus, display device 104 may, for example, comprise a conventional television that has a set-type box capability, allowing it to interact upon user command with a central processor, typically positioned at a remote location. Display device 104 may, in the alternative, comprise a personal computer connected to the Internet with conventional input capability in the form of a keyboard, mouse, or the like. Display device 104 may, in the alternative, comprise a smart phone with appropriate input capability. Display device 104 may even comprise a conventional radio that includes interactive capabilities, and that is coupled to a central processor. Such coupling might be through a separate Internet connection, for example.

The system of FIG. 1 further includes an interactive console 106 that is associated with display device 104 and provides a capacity to generate a referral system and the identity of a target individual to whom the referral is to be made in response to user input. The system of FIG. 1 further includes an advertising generator function 108 and a content/advertisement merger function 110. Both of these functions are shown in FIG. 1 as being incorporated in a processor 112. Storage repository 114 for recommended advertisements storage repository and storage repository 116 for default advertisements storage repository are shown associated with processor 112 in the system of FIG. 1.

The system of FIG. 1 further discloses a storage repository media 118 that includes the normal video and audio programming that is typically provided to display device 102 when display device 102 is a television. When display device 102 takes the form of a personal computer connected to the Internet, storage repository 118 includes website material. Obviously, in either case, storage repository 118 is merely representative of conventional sources of all shapes and forms of programming and/or Internet content.

In the implementation of the system disclosed by way of example in FIG. 1, a User A may be watching television or searching the Internet on display device 104. User A may then observe an advertisement of interest. For example, User A may observe an advertisement for an automobile that she thinks would be of interest to User B because she knows that User B is in the market for a new car. Using her interactive console 106, User A indicates that she recommends the automobile advertisement she is viewing to User B.

When making the recommendation, User A may optionally append a note to the advertisement to indicate that it was from her and that she thought User B would like this particular car because of some features referenced in the advertisement.

User A might optionally also provide a ranking on the advertisement, indicating the degree to which she thinks User B would be interested.

User A's referral is submitted to processor 112 over a conventional communication channel, such as the Internet, interactive cable, or the like. The advertisement (or, in the alternative, some mechanism to locate the advertisement, such as a pointer or other form of address), annotation, and ranking are stored in a repository of recommended advertisements 114. Again, the repository of recommended advertisements in storage repository 114 of FIG. 1 is intended to be indicative of any medium that has the capacity to act as storage.

The particular advertisement submitted by User A is marked for delivery to User B. Thus, at some later point in time, for example, when User B is watching television or searching the Internet on display device 102, a version of that advertisement is made to appear on display device 102. The version presented on display device 102 may be identical to the advertisement version seen by User A, or it may be an alternative version.

In either event, the version of the advertisement presented on display device 102 preferably includes an indication of the fact that the advertisement was referred to User B by User A. Moreover, a ranking given to the advertisement by User A may also be supplied.

It is possible to intersperse the referred annotated advertisement with conventional advertisements. For example, advertising generator function 108 may be operated to provide advertisements to be displayed at the first commercial break in the programming that User B is watching, or on User B's first visit to a website. Advertising generator function 108 may be triggered in real time as User B is operating display device 102, or advertising generator function 108 may have performed its launch prior to activation by User B of display device 102.

In one embodiment, advertising generator function 108 takes the advertisement that has been referred to User B from the repository of recommended advertisements 114 and inserts that advertisement into the programming flow through operation of content/advertisement merger function 110. Thus, one of the advertisements that User B sees in a series of conventional advertisements in a programming break or when viewing a website is the one recommended by User A. Often website advertisements consist of only still images.

This advertisement might be augmented with annotations provided by User A, perhaps as a subtitle in the video stream or as related audio text, either as part of television programming or as part of the observed Internet webpage.

Thus, advertising generator function 108 can select from either the repository of recommended advertisements 114 or the repository of default advertisements 116. For example, advertising generator function 108 may select two conventional advertisements from the repository of default advertisements 116 and the advertisement that was directed by User A to User B from the repository of recommended advertisements 114. These advertisements are then all inserted into the programming flow by content/advertisement merger function 110. Thus, one of the advertisements that User B will witness on display device 102 during a programming break or when observing a website is the one recommended by User A. And, as noted above, this advertisement is preferably augmented with annotations provided by User A, perhaps as subtitles in the video stream or as related text on a webpage.

There are several locations within a conventional network application domain where advertising generator function 108 and content/advertisement merger function 110 could be located. In a video network, for example, the selection of advertisements by the advertising generator function 108 and the content/advertisement merger function 110 could be located within a set-top box of a particular user or could be located in a head-end of a cable network.

Similarly, when delivering computer-based advertisements in an Internet environment, the advertisements could be inserted at a web server or stored in advance on a user's client device, and inserted dynamically from there. In cases where the logic is in a client's device, recommended advertisements could be downloaded to the client device in advance of the time they are needed. The client device would be instructed as to when to insert a locally stored advertisement, either on a schedule or on an on-demand basis. This is analogous to the way that local television stations insert commercials into national network broadcasts in particular time slots.

It should be noted that the advertisement that User A observed and the advertisement delivered to User B need not be identical. The advertiser could develop advertisements intended to attract the attention of referrals from User A and then have different advertisements for the same product that are aimed at potential buyers, for example, User B. Thus, there could be a mapping database in the system that correlates the referred advertisement to the advertisement to be delivered to the recipient.

Also, as mentioned above, the advertisement seen by User B could be augmented to include annotations provided by User A or others.

The advertisement selection process could be extended if the participant users are linked together as a group of friends, perhaps as members of electronic social networks such as Facebook or Twitter. In that case, advertising generator function 108 could look for recommendations from several of User B's friends or buddies before selecting an advertisement. The advertisement could be selected, for example, by summing the recommendations for advertisements for User B and selecting the one recommended by the largest number of friends or the one having the highest cumulative ranking.

If User B were part of more than one social network, a ranking could be weighted based on the primary purpose of the network and the type of product involved. For example, recommendations that came from contacts in LinkedIn, a business-related social network, could be given higher weight for business-related advertisements, such as for hotels for business travel.

Similarly, recommendations that came from Facebook, a personal social network, could be given higher weight for advertisements related to personal purchases, such as music or movies. The weighting of recommendations could also be based on preferences specified by User B, who could select to weight more highly the recommendations from certain users or groups for certain categories of products.

Alternatively, advertising generator function 108 could query User B's friends for additional information. If User A recommended an advertisement for a particular product for User B, other friends of User B could be queried with the advertisement or with other information about the specific product to gain their opinion on whether it would be of interest to User B.

Prior systems have looked to selecting advertisements based on the activities of others in a social group, but in this case, the invention actively solicits the input of these people and seeks referrals to specific targets, be they groups or individuals.

Advertisements could be in any form or combination of forms of media, including audio, video, text, and/or images.

The system of the present invention could also include financial incentives for users to make recommendations. For example, a user could receive a discount on a service (i.e., cable-television bill, Internet access) if she recommends more than five advertisements per month. The financial incentives for user referral input could also depend on the actions of those who receive the advertisements. For example, User A could receive a rebate on a recommended product if User B, to whom she referred the advertisement for that product, in fact made a purchase of the product.

There may be a need to limit the number of people to whom a user can refer advertisements. Without such limits, users could attempt to game the system by making a large number of referrals to strangers in order to build up their potential discounts. Such operating instructions could be implemented in a manner similar to the way in which instant messaging and related systems require user acknowledgment prior to sharing personal information with others.

Thus, the present invention provides customized advertisements that are recommended by human users rather than being determined strictly by a computerized system. Human users are aware of the needs and tastes of friends and people within their social network. Advertisements are inserted into the flow of normal programming rather than being delivered randomly to the recipient as an interruption. The proposed scheme can be applied to broadcast television where advertisements are inserted, and can be applied to Internet websites and even potentially to digital radio broadcasts.

The selection of advertisements can be based on the recommendation of users and the assignment of weights to different social groups.

Thus, the result of the present invention is intended to have users receive advertisements that are targeted to them by friends or relatives, potentially increasing the user's likelihood of viewing and/or interacting with the resulting advertisements.

The foregoing description has been presented for purposes of illustration. It is not exhaustive and does not limit the invention to the precise forms or embodiments disclosed. Modifications and adaptations of the invention can be made from consideration of the specification and practice of the disclosed embodiments of the invention. For example, one or more steps of methods described above may be performed in a different order or concurrently and still achieve desirable results.

Other embodiments of the invention will be apparent to those skilled in the art from consideration of the specification and practice of the invention disclosed herein. It is intended that the specification and examples be considered as exemplary only, with a true scope of the invention being indicated by the following claims.

What is claimed is:

1. A method for providing an annotated advertisement referral for presentation on an electronic device comprising the steps of:
receiving at an electronic processor an indication of a referral of an advertisement and the identity of a target to whom the advertisement is referred; and
directing an electronic signal representing a version of said advertisement to a first electronic device associated with said target to whom the advertisement is referred.

2. The method of claim 1, wherein said advertisement has visual and audio components.

3. The method of claim 1, wherein said advertisement has only still images components.

4. A method for providing an annotated advertisement referral for presentation on an electronic device comprising the steps of:
receiving at an electronic processor an indication of a referral of an advertisement and the identity of a target to whom the advertisement is referred; and
directing an electronic signal representing a version of said advertisement to a first electronic device associated with said target to whom the advertisement is referred, said version of said advertisement including an indication of the origin of said referral.

5. The method of claim 4, wherein said advertisement has visual and audio components.

6. The method of claim 4, wherein said advertisement has only audio components.

7. The method of claim 4, wherein said indication of a referral of the advertisement and the identity of the target to whom the advertisement is referred is received from a second electronic device on which said advertisement had been viewed.

8. The method of claim 4, wherein said version of said advertisement including an indication of said referral is scheduled to be presented on said first electronic device in a sequence with other advertisements.

9. The method of claim 4, wherein said first electronic device includes a television and said version of said advertisement including an indication of the origin of said referral is scheduled to be displayed on said first electronic display device during a commercial break of a program being displayed in said television.

10. The method of claim 4, wherein said first electronic device includes a monitor for interfacing with the Internet and said version of said advertisement including an indication of the origin of said referral is scheduled to be displayed on said first electronic device during display of a website on said monitor.

11. The method of claim 4, wherein said step of receiving includes receiving an indication of a rating being attributed to said advertisement.

12. The method of claim 11, wherein said version of said advertisement further includes an indication of said rating.

13. The method of claim 11, wherein said step of receiving includes receiving referrals with an indication of a rating for a plurality of advertisements from a plurality of sources.

14. The method of claim 13, wherein said step of directing includes first analyzing said ratings of said advertisements to determine which said advertisements referred to said first target will be directed to said first target.

15. A method for providing an annotated advertisement referral for an electronic device comprising the steps of:
directing a first electronic signal representing an advertisement to a first electronic device;
receiving at an electronic processor a second electronic signal from said first electronic device indicating a referral of that advertisement and the identity of a target to whom the advertisement is referred; and
directing a third electronic signal representing a version of said advertisement to a second electronic device associated with said target to whom the advertisement is referred, said version of said advertisement including an indication of the origin of said referral.

16. The method of claim 15, wherein said advertisement has both visual and audio components.

17. The method of claim 15, wherein said advertisement has only still image components.

18. The method of claim 15, wherein a portion of said version of said advertisement directed to said second electronic device is essentially identical to said advertisement directed to said first electronic device.

19. The method of claim 15, wherein said step of receiving includes receiving an indication of a rating being attributed to said advertisement.

20. The method of claim 19, wherein said version of said advertisement directed to said second electronic device further includes an indication of said rating.

21. A system for providing an annotated advertisement referral for an electronic device, comprising:
a first interactive electronic device configured to present an advertisement and generate a referral signal and the identity of a target to whom the referral is being made in response to user input;
a second electronic device configured to present an advertisement; and
an electronic processor programmed to:
direct a first electronic signal representing a first advertisement to said first interactive electronic device;
recognize receipt from said first interactive electronic device of a referral signal; and
direct a second electronic signal representing a version of said advertisement to said second electronic device in response to said identity of a target to whom the referral is being made.

22. The system of claim 21, wherein said advertisement has both visual and audio components.

23. The system of claim 21, wherein said advertisement has only still image components.

24. The system of claim 21, wherein said first interactive electronic device includes a television.

25. The system of claim 21, wherein said first interactive electronic device includes a computer monitor.

26. The system of claim 21, wherein said first interactive electronic device includes a telephone.

27. The system of claim 21, wherein said second electronic device includes a television.

28. The system of claim 21, wherein said second electronic device includes a computer monitor.

29. The system of claim 21, wherein said second electronic device includes a telephone.

30. The system of claim 21, wherein said indication of an origin of said referral is based on the identity of said first interactive electronic device from which said referral was received.

31. The system of claim 21, wherein said electronic processor is further programmed to include in said second electronic device an indication of an origin of said referral.

32. The system of claim 21, wherein said first interactive electronic device is further configured to generate a rating signal in response to user input and said electronic processor is further programmed to:
recognize receipt from said first interactive electronic device of said rating signal; and
include in said second signal a representation of said rating signal.
